(19) United States
(12) Patent Application Publication
(10) Pub. No.: US 2012/0116916 A1
(43) Pub. Date: May 10, 2012

(54) SHOPPING ASSISTANCE SYSTEMS AND METHODS

(75) Inventor: Abbott Fleur, Bedford, NY (US)

(73) Assignee: Donation Source, Inc., Bedford, NY (US)

(21) Appl. No.: 13/288,629

(22) Filed: Nov. 3, 2011

Related U.S. Application Data
(60) Provisional application No. 61/411,751, filed on Nov. 9, 2010.

(51) Int. Cl. G06Q 30/00

(52) U.S. Cl. 705/26.7; 705/26.1

(57) ABSTRACT

Shopping systems and methods that automate the merchandise selection process are implemented for producing picking/shipping documents that allow the merchandise to be picked at a warehouse and sent to recipients. The initiator of the process is a purchaser that specifies the recipients' demographics and other parameters as they relate to the merchandise. The purchaser may also specify various constraints that both limit the amount of merchandise selected and filter the merchandise to better match the recipients' requirements as a group.

### CROSS REFERENCE TO RELATED PATENT APPLICATIONS

The present invention is related to, and claims priority from, U.S. Provisional Patent Application 61/411,751, filed Nov. 9, 2010, the disclosure of which, inclusive of all patents and documents incorporated therein by reference, is herein specifically incorporated by this reference in its entirety.

### FIELD OF THE INVENTION

The present invention relates generally to e-commerce and, more particularly, to the selection of products for a plurality of recipients for a purchaser that may know the demographics of the desired recipient population but may not know specific recipient individuals or their preferences for products.

### BACKGROUND OF THE INVENTION

There exists certain merchandise purchasing situations where the purchaser of merchandise may not know the individual recipients that will be receiving the merchandise and may or may not know the location(s) where the merchandise is to be shipped. The purchaser may have some knowledge about the demographics of the recipients collectively. With traditional systems, a purchaser typically uses demographics knowledge to individually select merchandise to be included in the shipment(s) to each individual recipient (e.g., a virtual shopping cart). In situations where there are thousands of available merchandise items to be selected for thousands of recipients, this task becomes both unwieldy and time consuming.

One example of this purchasing situation exists for individuals who want to donate books to a school or children's clinic. The donor may know the number of children and their age ranges or reading levels and would like to be able to purchase two different books for each of the children. The donor might also prefer that not all children get the same books. The donor might also want to make sure the books are for Christmas and not for Easter or Chanukah. If the number of children is large, it can be very time consuming and difficult for the donor to select appropriate books for each child.

### SUMMARY OF THE INVENTION

The present invention is directed to shopping systems and methods that automate the merchandise selection process, and may produce picking/shipping documents that allow the merchandise to be picked at a warehouse and sent to recipients. In an embodiment of the invention, the initiator of the process is a purchaser that specifies the recipients' demographics and other parameters as they relates to the merchandise. The purchaser may also specify various constraints that both limit the amount of merchandise selected and filter the merchandise to better match the recipients' requirements as a group.

In one aspect of the embodiment, the selection approach may give each piece of merchandise an equal opportunity to be included in the selection process. In addition, specific inventory items may be given priority in the selection process.

In another embodiment of the invention, the system may receive a list of specific merchandise to be included with the selected merchandise. Also, the system may generate a preview list of the merchandise to be shipped and may allow for item selection and quantity changes by the purchaser.

To facilitate merchandise distribution to recipients, picking/shipping documents may be generated by the system for each demographic group of the recipients. In the example above, books for each age or reading group could be shipped together.

### BRIEF DESCRIPTION OF THE DRAWINGS

FIG. 1 is a block diagram of an exemplary server based system for carrying out an embodiment of the present invention.

FIG. 2 is an exemplary process flow on the server of a purchaser request for merchandise to be selected and added to a merchandise list according to an embodiment of the present invention.

FIG. 2A is an exemplary process flow on the server of a purchaser request for merchandise to be selected and added to a merchandise list with a purchaser option to approve the merchandise list according to an embodiment of the present invention.

FIG. 3 is an exemplary process flow for the receipt of merchandise selection criteria from a purchaser according to an embodiment of the present invention.

FIG. 4 is an exemplary process flow for the receipt of purchasing constraints from a purchaser according to an embodiment of the present invention.

FIG. 5 is an exemplary process flow for the creation of the recipient matrix used in building the merchandise list according to an embodiment of the present invention.

FIG. 6 is an exemplary process flow for the selection of inventory item candidates for each of the recipient groups according to an embodiment of the present invention.

FIG. 7 is an exemplary process flow for the generation of a merchandise list for purchaser preview according to an embodiment of the present invention.

FIG. 8 is an exemplary process flow that describes the handling of merchandise list changes and approvals according to an embodiment of the present invention.

FIG. 9 is an exemplary process flow for the generation of merchandise list(s) according to an embodiment of the present invention.

FIG. 10 is an exemplary recipient group distribution matrix of exemplary recipient distribution group entries.

FIG. 11 is an exemplary process flow for the selection of inventory items based on distribution group quantity budget amount.

FIG. 12 is an exemplary process flow for the selection of inventory items with an even distribution of quantities based on distribution group recipient ratios.

FIG. 13 is an exemplary process for the selection of inventory items based upon a Product Value Proposition scale according to an embodiment of the invention.

### DETAILED DESCRIPTION

Embodiments of the present invention are hereafter described in detail with reference to the accompanying figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying figures is provided to assist in a comprehensive understanding of exemplary embodiments of the present invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The following terms, as defined here, are used throughout the description of the present invention and the claims.

As used herein, a “purchaser” refers to a person or system that specifies merchandise selection criteria, purchasing constraints and/or selected merchandise changes for the picking ticket(s).

As used herein, “recipient” refers to a person that will receive one or more merchandise items.

As used herein, “recipient attributes” refer to demographics, attributes or other properties of an individual “recipient”. Examples of “recipient attributes” include, but are not limited to: age, height, weight, gender, marital status, education level, language, and ethnicity.

As used herein, a “recipient group” refers to a set of recipients that share the same “recipient attributes” as they relate to the merchandise being purchased. A “recipient group” preferably contains a size property which represents the number of members in the group or the group's membership percentage as relates to all the “recipients”. Examples of this are: age related to book reading level and weight or height related to dress size.

As used herein, a “recipient distribution matrix” refers to the list of distinct “recipient groups” that categorizes all of the “recipients” as they relate to merchandise being purchased.

As used herein, “merchandise criteria” refers to properties of merchandise available for purchase that are used to associate or filter the item to a specific recipient group. Examples of these are: book reading level, book genre, and pants size.

As used herein, “merchandise type” preferably is merchandise that shares certain merchandise criteria traits allowing them to be referenced within the same “recipient matrix.”

As used herein, “merchandise list” is a list of inventory items and the associated quantities. The list may have a plurality of uses, including, but not limited to, merchandise item deletion, addition and quantity changes, as well as merchandise picking and shipping.

As used herein, a “distributor” refers to an entity that manages and ships inventory from a distribution facility to “recipients” as specified in a “merchandise list.”

As used herein, “usage aging” is a process that orders inventory items so that inventory items recently selected for an order go to the end of the list. This keeps more inventory items active, since their usage is cycled.

As used herein, an “inventory sales incentive” is associated with inventory items that a distributor wants sold out first. These items are always used first in the inventory selection process.

As used herein, a “target quantity” is the expected quantity to be shipped for each selected inventory item. This quantity is limited by the available inventory in stock and the total purchasing budget (e.g., if the target quantity is 50, the item price is $1 and selecting this inventory item will exceed the budget by $15, only 35 pieces of this item will be selected).

As used herein, “selection filters” refer to merchandise attributes that are used to include or exclude an item for consideration during item selection (e.g., for a book this might include hardcover, fiction, sports, Easter, etc.).

In accordance with an embodiment of the present invention, a purchaser wants to purchase a plurality of similar items (books, pants, shirts, school supplies, etc.) for a plurality of recipients. The purchaser may know how the items are associated with sub-sets (groups) of the recipient population and the relative size of those groups within the population.

Using the previously described books example, there may be 37 recipients in the “up to 3 years group”, 45 recipients in the “4 to 8 years” group, and so on. Using this recipient distribution information and knowing how many items are to be purchased or how much money is available for purchasing, the system of the present invention creates a merchandise list of items for shipment to the recipients.

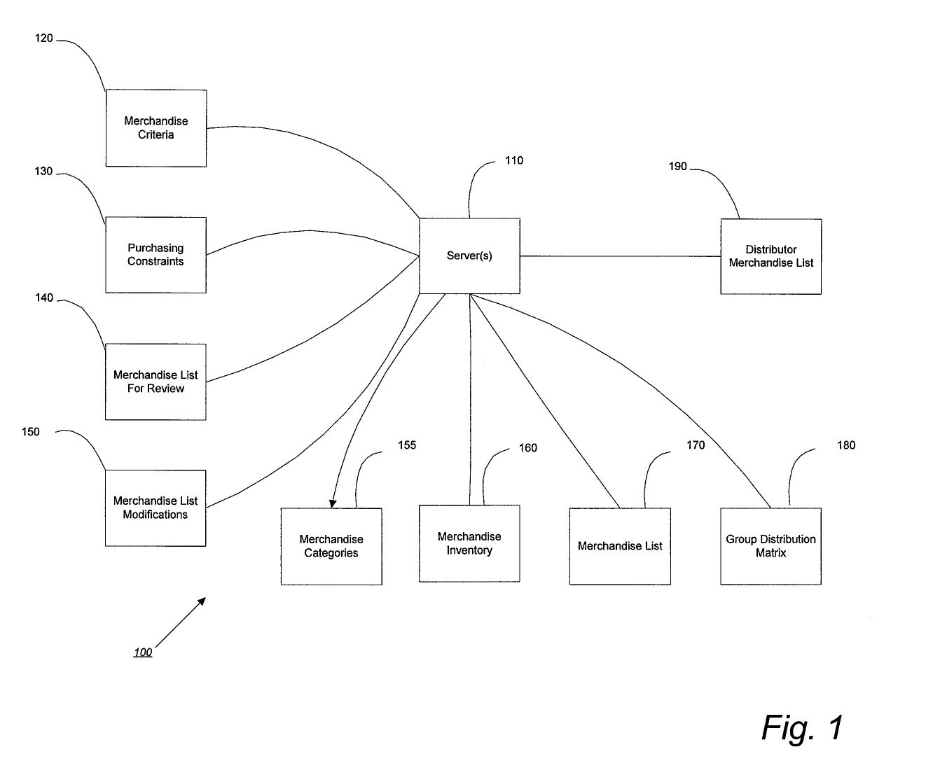

FIG. 1 is a block diagram of a server system 100 for carrying out an embodiment of the present invention. The e-commerce server 110 is a conventional computer system (e.g., an HP Edge server). Alternatively, it may be implemented as a server farm, co-located or distributed over a network. The e-commerce server receives Merchandise Criteria 120, Purchasing Constraints 130 from a purchaser and Merchandise Categories 155. From the received Merchandise Criteria 120, Purchasing Constraints 130 and Merchandise Categories 155, a Merchandise List for Review or Shipping List 140 is generated from the Merchandise Inventory 160. It is saved in Merchandise List 170 and made available for the purchaser to review. Merchandise List Modifications 150 to the Merchandise List 170 are received from the purchaser and the approved Distributer Merchandise List 190 is created by the system for presentation to the distributor. It is preferable throughout the generation process that the Group Distribution Matrix 180 maintains the state of the automated selection process.

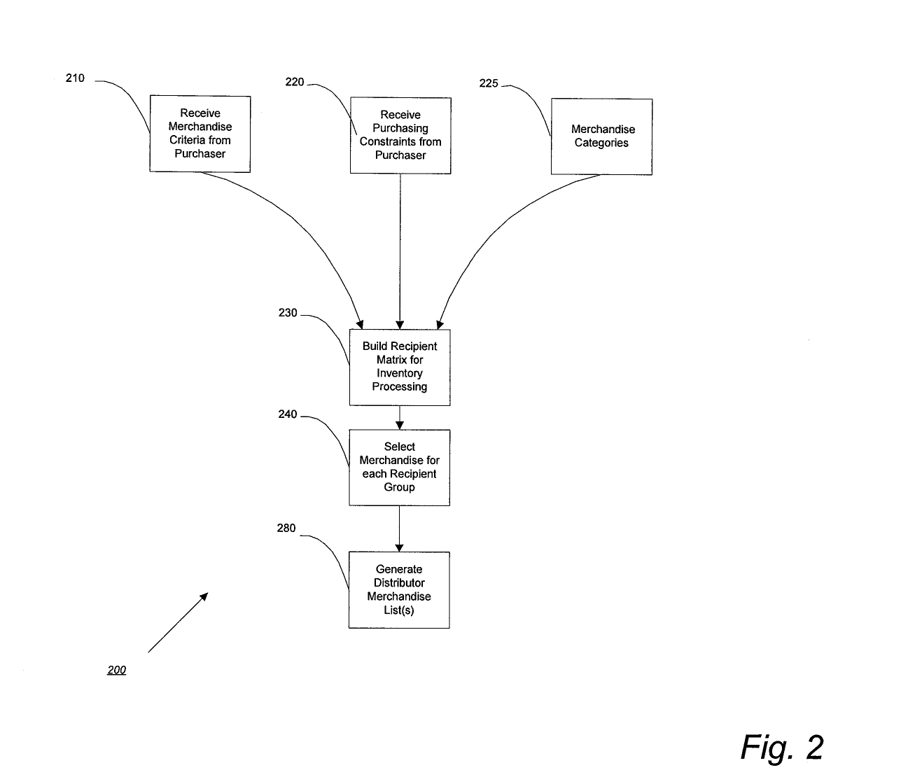

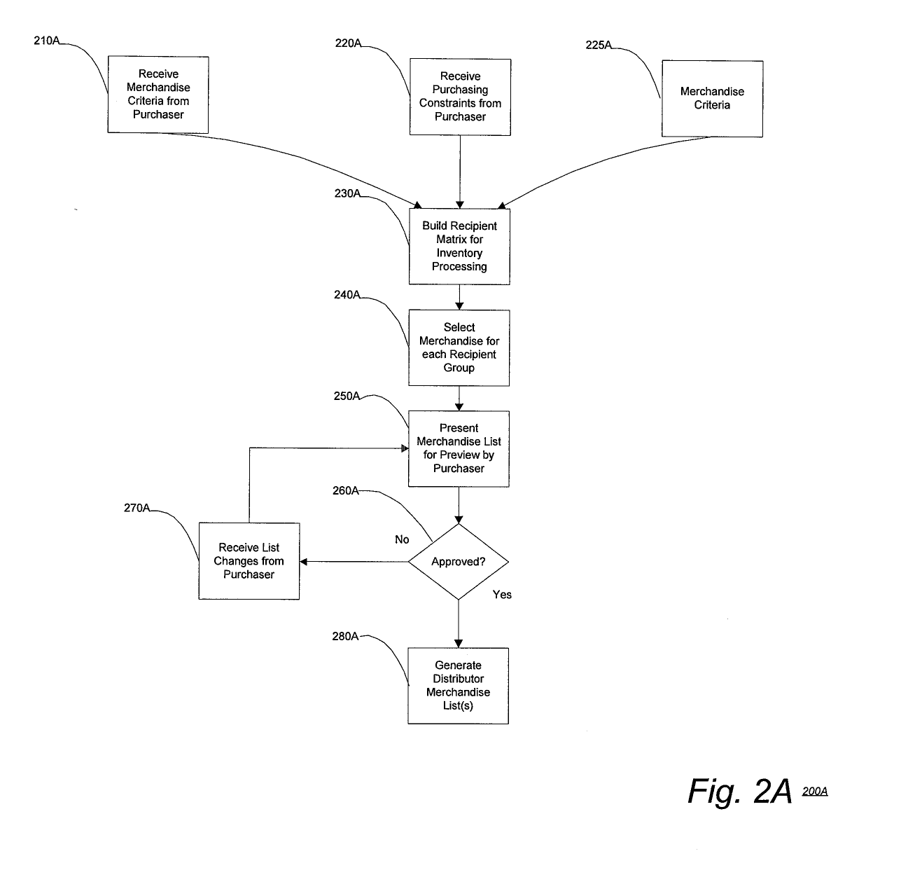

An exemplary embodiment of the server system 200 according to an embodiment of the invention is shown in FIG. 2 in which a server receives merchandise criteria from a purchaser at step 210. The server may then receive purchasing constraints from the purchaser at step 220. The server may use the merchandise criteria, purchasing constraints, and/or Merchandise Categories 225 to build a recipient matrix that may be used for inventory processing at step 230. The server may next select merchandise for each recipient group in the recipient matrix at step 240. The server may then generate distributor merchandise list(s) for the distributor at step 280.

Another embodiment of the server system 200A is shown in FIG. 2A in which a server receives merchandise criteria from purchaser at step 210A. The server may then receive purchasing constraints from a purchaser at step 220A. The server may use the merchandise criteria, purchasing constraints, and/or Merchandise Criteria 225A to build a recipient matrix that may be used for inventory processing at step 230A. The server may next select merchandise for each recipient group in the recipient matrix at step 240A. The merchandise list of selected merchandise may be presented to the purchaser for preview at step 250A. If the merchandise list is approved as per step 260A, the server may generate distributor merchandise list(s) for the distributor at step 280A. If the merchandise list is not approved, but changed by purchaser as per step 260A, the list is changed and the changed list is received from the purchaser at step 270A. The process presents the merchandise list again presented to the purchaser for approval at step 250A.

The following descriptions provide details regarding the process 200 shown in FIG. 2. The same details apply equally to the corresponding process steps in process 200A of FIG. 2A.

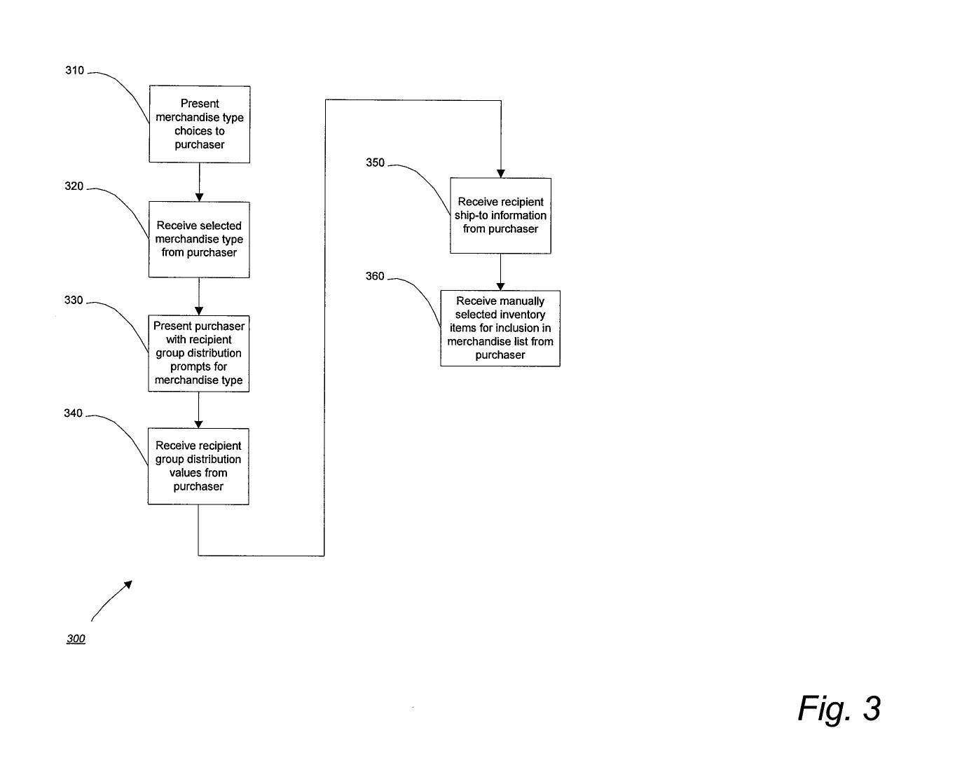

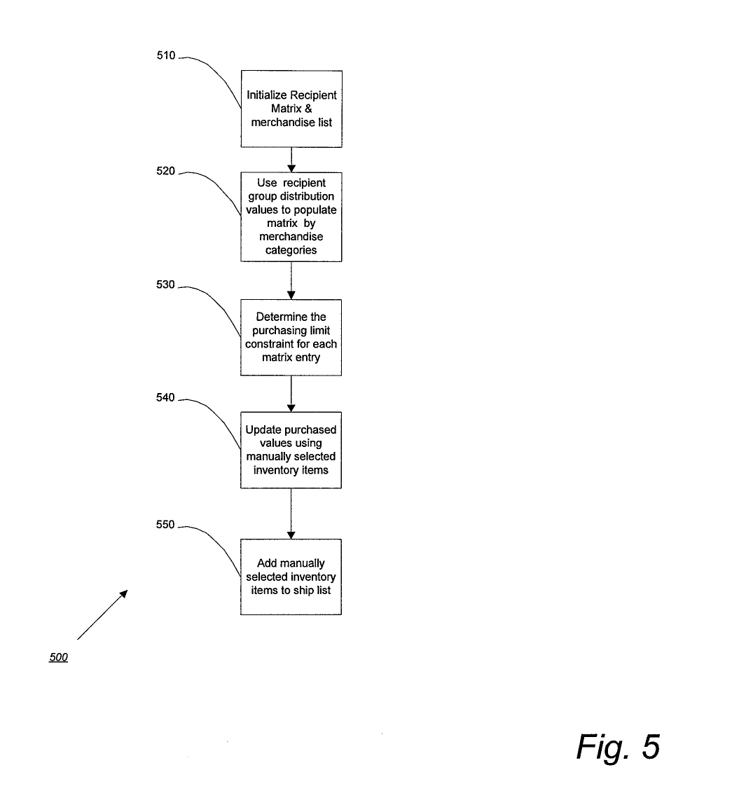

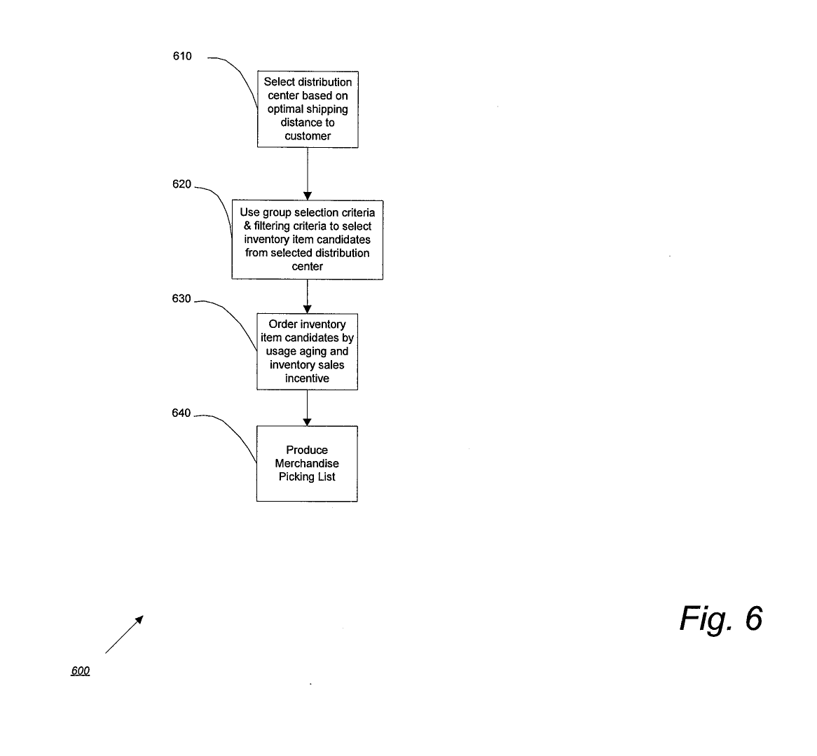

Server 110 receives merchandise criteria from a purchaser at step 210 (210A) in process 300 as detailed in FIG. 3 according to an embodiment of the invention. The server presents to the purchaser the various merchandise types that can purchased through the invention at step 310. The server then receives the selected merchandise type from the purchaser at step 320. Using the merchandise type, the server constructs distribution prompts to be presented to the purchaser at step 330. The distribution prompts describe the various groups that the recipient population could contain. For example, using a merchandise type of books, the prompts could be reading levels (up to 3 years, 4 to 8 years, etc.). The server may next receive the group distribution values from the purchaser at step 340. These values, which could be recipient counts or the percentage the group represents of the entire recipient population, or some other indicator of population distribution or the like, may be used to build the recipient group matrix (see FIG. 5). The server may receive ship-to information from the purchaser at step 350. The ship-to information may be used to determine the optimal distribution center to use to reduce freight costs (see step 610 of FIG. 6). Optionally, the server may next receive manually selected inventory items from the purchaser at step 360. These may be used to initially seed the merchandise list and could be the starting point for the automated item selection process.

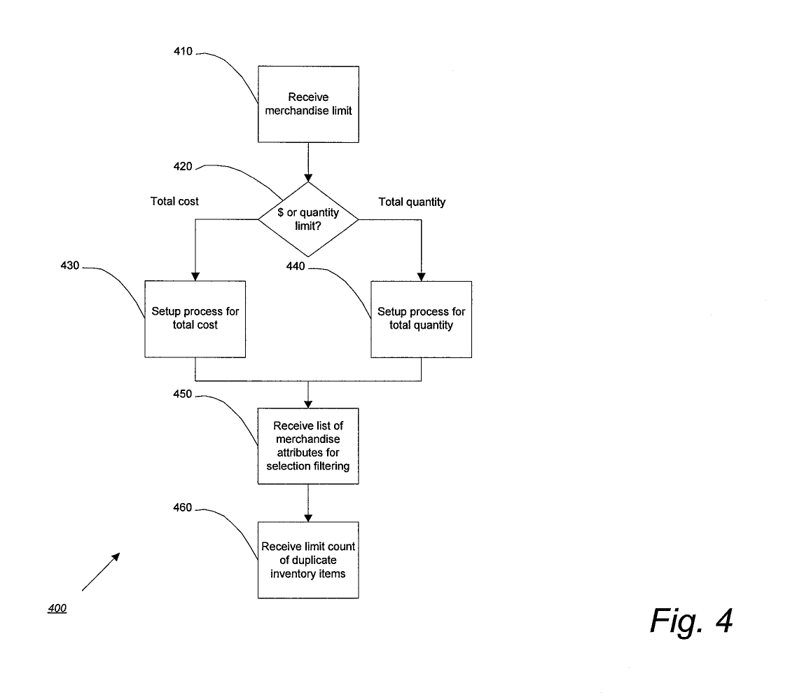

Server 110 receives purchasing constraints from purchaser at step 220 (220A) in process 400 as detailed in FIG. 4 according to an embodiment of the invention. The server receives a merchandise limit from the purchaser at step 410. The merchandise limit can be, but is not limited to, total units to be selected or total budget available for creating the merchandise list. Based upon the type of merchandise limit entered 420, the selection process limits each recipient group by total cost of the merchandise at step 430 or by total quantity at step 440. The server next receives a list of merchandise attributes to be used for filtering the selections 450 contained in the inventory selection candidates. These candidates can be rejection attributes (e.g. don't select picture books or books about religious subjects) or selection attributes (e.g. only select books about Easter or books popular among girls). The server next receives a limit count of duplicate inventory items at step 460 which may be used to constrain the number of a single inventory item.

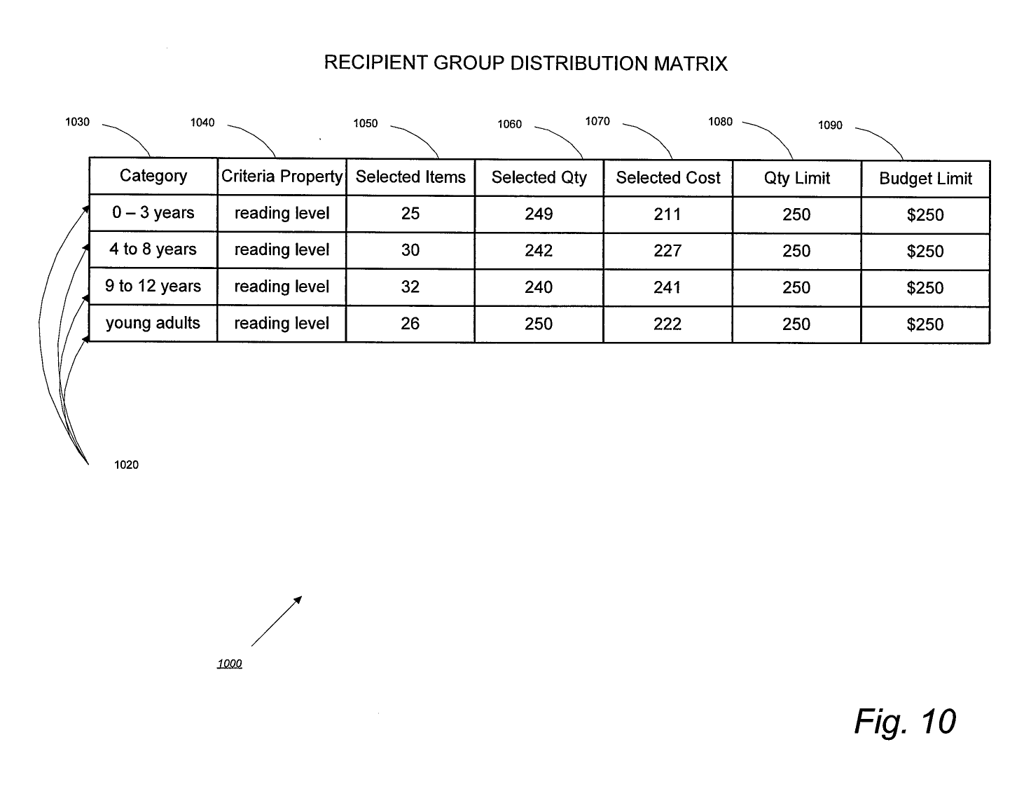

Server 110, using the information received from the purchaser, builds the recipient matrix that is used for inventory selection processing 230 (230A) is process 500 as detailed in FIG. 5 according to an embodiment of the invention. Both the group distribution matrix (see FIG. 10) and the merchandise list are initialized in this process at step 510, by creating a new, empty distribution matrix and an empty merchandise list. Using the previously received group distribution values and merchandise prompts, the matrix entries are initialized at step 520. The received merchandise limit is allocated among the group entries in the matrix based upon the group distribution values 530. An example of this is if the limit is $1,000 and the group values are 20%, 30%, 25%, and 25%, the individual group budget limits could be $200, $300, $250, and $250. Another example of this is if the limit is $1,000 and the group values are 20%, 30%, 25%, and 25%, the server selects the inventory items so that each group maintains its approximate ratio of books which might be 40, 60, 50, and 50. For each manually selected inventory item at step 540, the server updates the unit count and total cost of the associated group distribution matrix entry, adding the inventory item to the merchandise list at step 550.

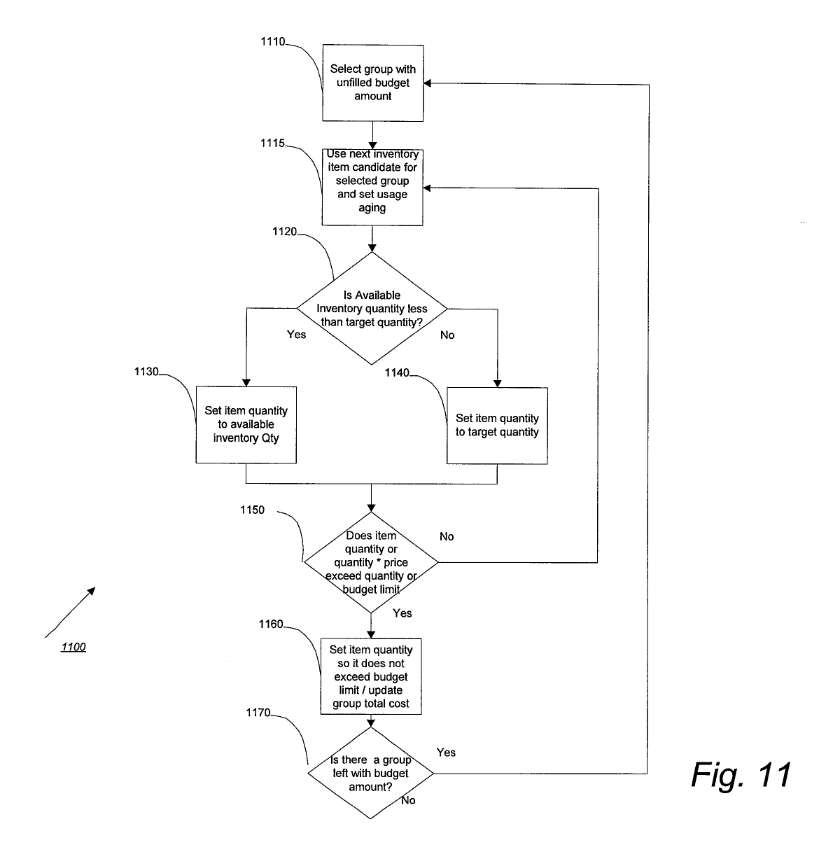

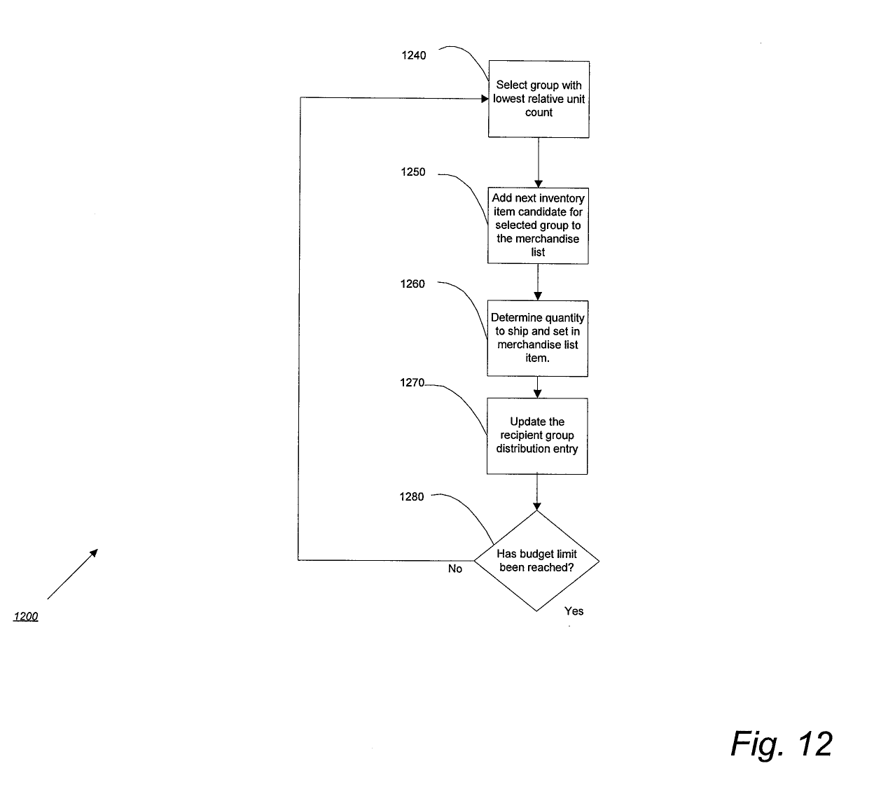

Server 110 selects the merchandise 240 (240A) for each recipient group in process 600, which is detailed in FIG. 6 according to one embodiment of the invention. The process starts with the selection of a distribution center based upon optimal shipping distance to the customer at step 610. The sever 110 then selects inventory item candidates from the available inventory of the selected distribution center at step 620. The items are selected using the merchandise category (see 1030 from the criteria property 1040 of the merchandise inventory and the selection filter(s) optionally received from the purchaser in FIG. 10. The inventory item candidates are preferably ordered, for example, by both inventory usage aging and inventory sales item incentive at step 630. The inventory item candidates may be used to produce a merchandise picking list in step 640. One embodiment of this step is detailed in FIG. 11. Another embodiment of this process is detailed in FIG. 12.

In one embodiment of step 640, server 110 produces a merchandise list 1100, which is detailed in FIG. 11. Each distribution group is chosen at step 1110. At this step, a group with an unfilled budget amount (quantity or money) is selected. The next inventory item candidate for the selected group is added to the merchandise list and the inventory item's usage aging is set to the current date time at step 1115. At step 1120, if the available inventory is less than the target quantity, the item quantity is set to the available inventory at step 1130. If there is sufficient available inventory, the item quantity is set to the target quantity at step 1140. If either the item quantity or item extension (quantity*price) exceeds the budget (quantity or money) at step 1150, the item quantity is set so that the group does not exceed its budget at step 1160. If the item is within budget, the server goes back to use the next inventory item at step 1115. If there is a group left with an unfilled budget amount at step 1170, the next group with unfilled budget is selected at step 1110.

In an alternative embodiment of step 640, sever 110 produces a merchandise picking list 1200, which is detailed in FIG. 12. This process distributes inventory quantity across groups based upon the ratio of the recipients in each group. The distribution group with the lowest relative unit count is selected at step 1240. An example of this is if the group values are 25%, 25%, 25%, and 25%, and the total inventory quantity currently selected is 80, any group with 20 or less quantity will be selected. For the selected group, the next inventory item candidate is added to the merchandise list at step 1250. The quantity to ship is set so as not to exceed the overall budget at step 1260. The recipient group entry is updated in step 1270. If the budget limit has not yet been reached at step 1280, the next group is selected at step 1240.

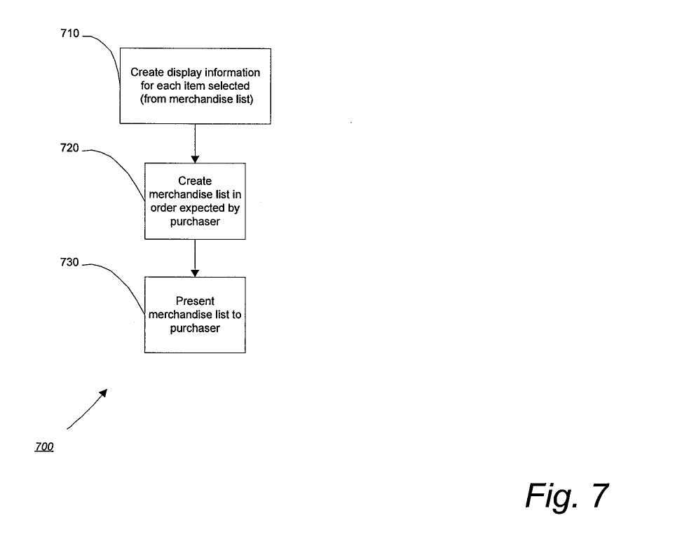

Optionally, when the selection process 240A completes, the server 110 presents a merchandise list to the purchaser for review 250A at process 700, which is detailed in FIG. 7 according to one embodiment of the invention. For each item in the merchandise list, the server 110 creates a display panel with the appropriate inventory information (text, images, quantity, cost, etc.) at step 710. The server may sort the completed panels into an order expected by the purchaser at step 720. The server may present the ordered merchandise list to the purchaser at step 730. After the merchandise list is reviewed, the server 110 receives either an approval or a change to the merchandise list 260A.

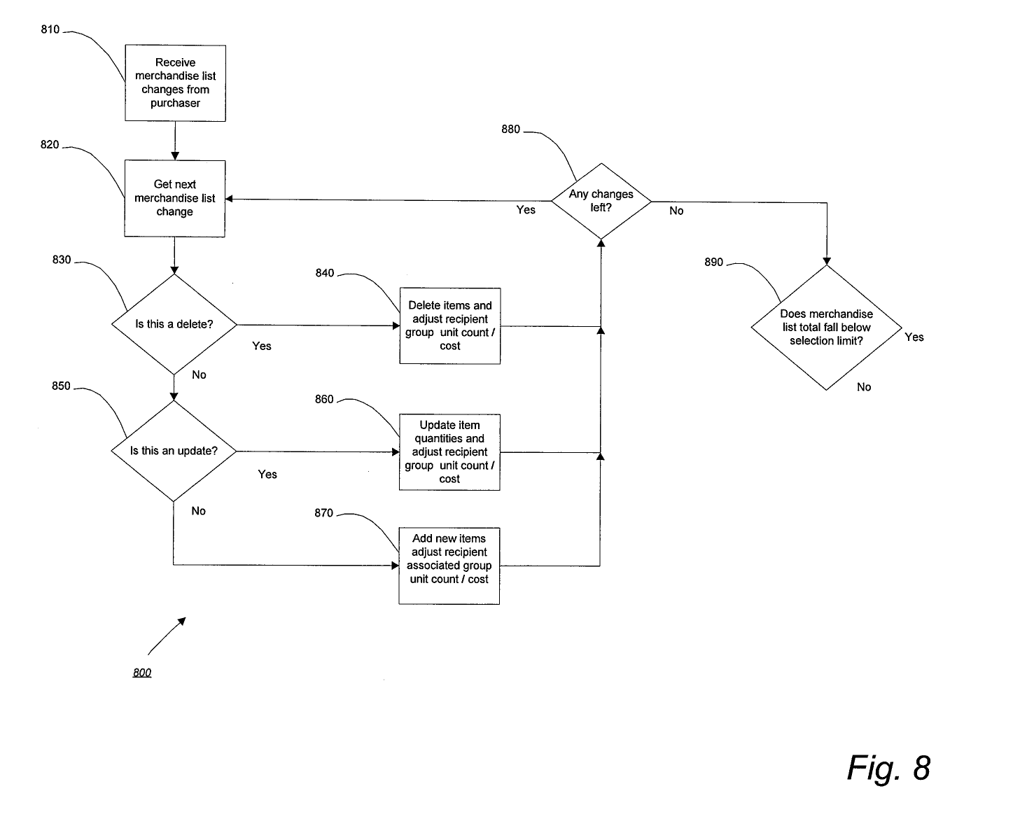

If the merchandise list is not approved, the server 110 receives merchandise list changes from the purchaser 270A at process 800, which is detailed in FIG. 8 according to one embodiment of the invention. The server receives the list of merchandise list changes from the purchaser at step 810. The system selects the next change from the list of changes at step 820. If the change is a delete (step 830), the merchandise item entry is deleted and the group unit count and cost are reduced accordingly at step 840. If the change is an update (step 850), the merchandise list line item quantity is adjusted and the group unit count and cost are changed accordingly at step 860. For any new merchandise items added at step 870, a new merchandise list item is created with the associated quantity and cost and the group unit count and cost are changed accordingly. If there are any change items left in the change list at step 880, the process goes back to step 820. If the selected item total falls below merchandise limit or the total cost falls below the cost limit at step 890, the distribution groups are updated using the group selection process in FIG. 6.

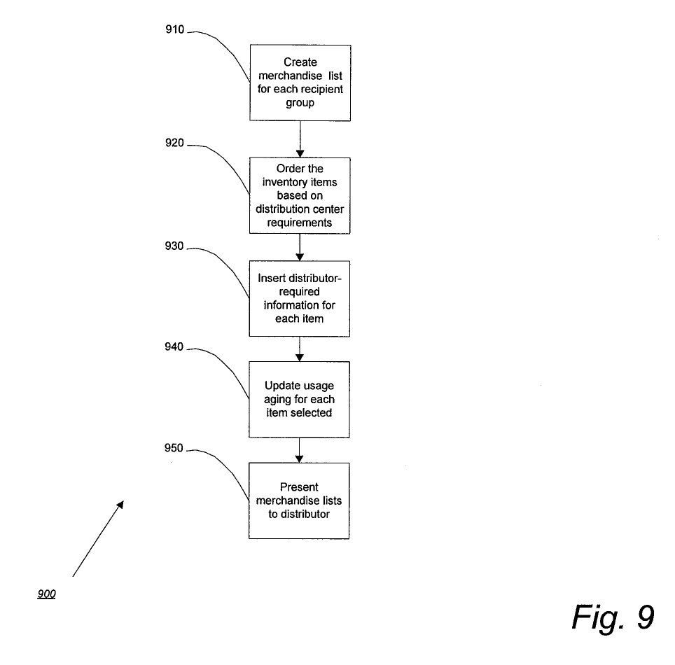

Once the merchandise list is approved in 260A, the distributor merchandise list(s) are created 280 (280A) at process 900, as in FIG. 9 according to one embodiment of the invention. The server creates a merchandise list for each recipient group at step 910. The inventory items of each group merchandise list are preferably ordered based upon the picking requirements of the distribution center at step 920. Optionally, any distributor preferred information for each inventory item is inserted into the merchandise list at step 930. For each inventory item, its last used date/time of selection is updated to support the usage aging process for merchandise selection at step 940. The server sends the completed merchandise list (for each recipient group) to the distribution center at step 950.

The chart in FIG. 10 is an exemplary embodiment of a recipient group distribution matrix 1000. There may be an entry in the matrix for each recipient distribution group 1020. Each entry may contain the following:

| | | |
|---|---|---|
| Category | 1030 | This is the category name that is used by the |
| | | purchaser at step 340 to supply group |
| | | distribution values and in the selection of the |
| | | inventory selection candidates at step 620. |
| Criteria | 1040 | The criteria property is the location in the |
| Property | | inventory store that contains the various |
| | | categories. This is used during the creation |
| | | of the inventory selection candidates at step |
| | | 620. |
| Selected | 1050 | This is the count of the number of items that |
| Items | | have been selected for this recipient |
| | | distribution group. It is updated during the |
| | | inventory selection process at step 640 and |
| | | during merchandise list updating at steps |
| | | 840, 860, 870. |
| Selected | 1060 | This is the total number of units that have |
| Qty | | been selected for the recipient distribution |
| | | group. It is used during the selection at step |
| | | 660 and updating process at steps 840, 860, |
| | | 870. |
| | | This value may be compared to the Limit |
| | | when limits are set by item count. |
| Selected | 1070 | This is the extended total cost of the inventory |
| Cost | | items selected for the recipient distribution |
| | | group-the sum of item quantity times item price. |
| | | It is used during the selection at step 1160, 1270 |
| | | and updating process at step 840, 860, 870. This |
| | | value may be compared to the Limit when limits |
| | | are set by total item price. |
| Quantity | 1080 | This is the quantity limiting value for determining |
| Limit | | when to cut-off the inventory selection process. It |
| | | is used during the selection at step 660 and |
| | | updating process at step 1150. |
| Budget | 1090 | This is the budget limiting value for determining |
| Limit | | when to cut-off the inventory selection process. |
| | | It is used during the selection at step 1150 and |
| | | updating process at step 840, 860, 870. |

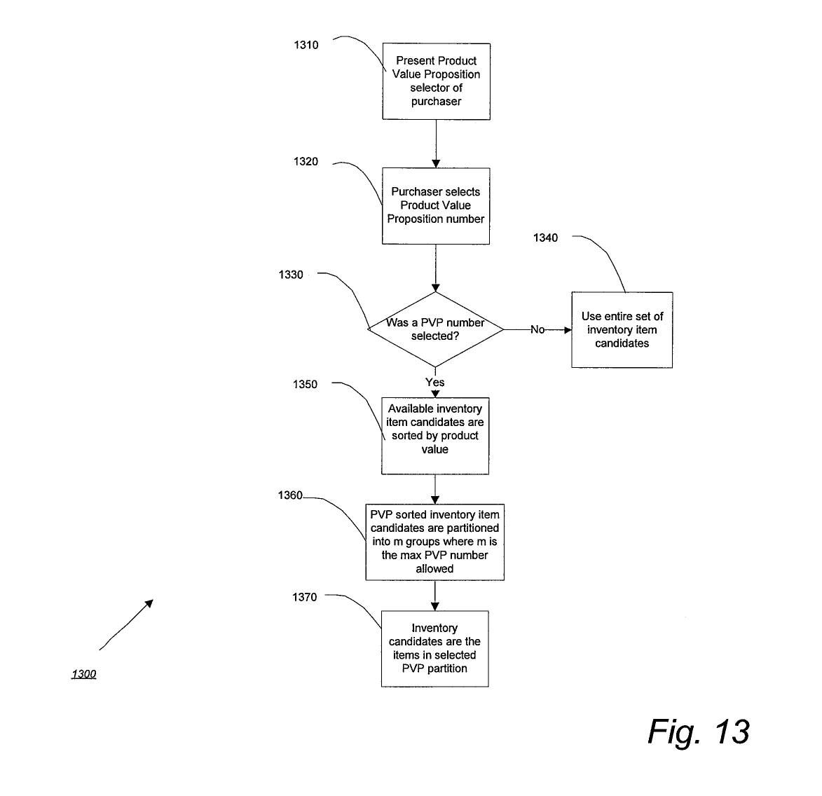

FIG. 13 is an exemplary process for the selection of inventory items based upon a Product Value Proposition scale according to an embodiment of the invention.

Product Value Proposition (PVP) is a numeric value that relates the price of a product to its value to the customer. In its simplest form, it can be the ratio of MSRP to sales price. The higher the value of the PVP, the greater the quantity of product that can be purchased for the same budget amount (hence higher value).

Value balancing could be implemented as a simple slider control where the higher the slider value, the higher the product values selected for item candidates.

Server 110 receives a Product Value Proposition (PVP) number from purchaser in 1300 as detailed in FIG. 13. The server presents to the purchaser a range of PVP numbers that can be selected (including no selection in step 1310). The server then receives the selected PVP number from the purchaser at step 1320. If the purchaser did not select a PVP number in step 1330, then use entire set of inventory item candidates in step 1340. If the purchaser selected a PVP number in step 1330, then available inventory items candidates are sorted by product value in step 1350. Using the PVP number supplied in step 1330, the sorted inventory item candidates are portioned into m groups where m is the maximum PVP number allowed in step 1360. The new set of inventory item candidates are the members of the partition with the supplied PVP number in step 1370.

The process in FIG. 6 for selection of inventory includes an additional set of steps that select a subset of the merchandise list based on PVP. If no PVP is specified, the entire set of merchandise candidates are used.

In an embodiment, the present invention can be implemented in software as executed by a central processing unit. Software programming code, which can embody the present invention is typically accessed by a microprocessor from long-term, persistent storage media of some type, such as a flash drive or hard drive. The software programming code may be embodied in any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

While the invention has been particularly shown and described with reference to a preferred embodiment thereof, it will be understood by those skilled in the art that various other changes in the form and details may be made without departing from the spirit and scope of the invention.

What is claimed is:

1. A control system for automating merchandise selection, comprising:
a process for receiving merchandise selection criteria from a purchaser;
a process for receiving merchandise constraints from the purchaser; and
a process for creating a recipient distribution matrix based on the merchandise selection criteria and the merchandise constraints.

2. The system of claim 1 wherein the recipient distribution matrix is used for selecting merchandise for shipment.

3. A control system comprising a process for generating a merchandise list based on a merchandise selection criteria and a merchandise constraints received from a purchaser.

4. The system of claim 1 further comprising a process for providing the purchaser with choices of merchandise type.

5. The system of claim 1 further comprising a process for receiving a merchandise type from the purchaser.

6. The system of claim 1 further comprising a process for providing the purchaser with merchandise type recipient distribution matrix prompts.

7. The system of claim 1 further comprising a process for receiving recipient group distribution matrix limits from the purchaser.

8. The system of claim 1 further comprising a process for receiving shipment destination information from the purchaser.

9. The system of claim 1 further comprising a process for receiving specific inventory item selections specified by the purchaser.

10. The system of claim 1 wherein the merchandise constraints comprise a maximum monetary amount that the purchaser is willing to pay.

11. The system of claim 1 wherein the merchandise constraints comprise a maximum number of items to be purchased.

12. The system of claim 1 wherein the merchandise constraints comprise a list of merchandise attributes used to filter available inventory, and wherein the merchandise attributes may include required inventory selection and rejection attributes.

13. The system of claim 1 wherein the merchandise constraints comprise a duplicate inventory item limit to set a maximum number of a single inventory item to be purchased.

14. The system of claim 1 further comprising a process for receiving group population distribution information used for determining a group inventory item limit comprising a maximum number of items to be purchased for the group.

15. The system of claim 3 further comprising a process for selecting inventory items for each selection group of a plurality of selection groups based upon a recipient distribution matrix created by a second control system based on the merchandise selection criteria and the merchandise constraints, wherein the second control system further uses filtering constraints of recipient group distribution matrix limits and a list of merchandise attributes used to filter available inventory items, and wherein a subset of the available inventory items is selected as inventory item candidates for the selection group.

16. The system of claim 15 further comprising a process for using a group inventory item limit and a duplicate inventory item limit to scan a group of inventory item candidates, selecting individual inventory items and quantities of the individual inventory items to be included in the merchandise list, wherein first items in the merchandise list comprise specific inventory items from the purchaser.

17. The system of claim 3 further comprising a process for returning to the purchaser a merchandise list of all inventory items selected.

18. The system of claim 3 further comprising a process for processing for approval of the purchaser, wherein the processing comprises receiving from the purchaser either approving or changing the merchandise list; and releasing approved merchandise lists to a distribution system, wherein changing the merchandise list may include removing items, changing item quantities, and/or adding new items from an available inventory.

19. The system of claim 18 wherein changing the merchandise list may include removing items, changing item quantities, and/or adding new items from an available inventory.

20. The system of claim 3 further comprising a process for creating separate merchandise lists for each selection group of a plurality of selection groups.

21. The system of claim 16 further comprising a process for inventory usage aging comprising recording a last time an inventory item was selected; setting an order of item selection by oldest use; and assuring that all inventory items are used in a selection process.

22. The system of claim 21 further comprising a process for bypassing the process for inventory usage aging through an inventory sales incentive configured to give specified inventory items precedence over aged items.

23. The system of claim 15 further comprising a process for constraining the inventory candidates to a distribution center logistically closest to a shipment destination.

24. The system of claim 16 further comprising a process for balancing the selection of inventory item candidates based upon each group's distribution ratio of inventory items.

25. The system of claim 15 further comprising a process for selecting a subset of inventory items based upon a Product Value Proposition scale.

26. A method of automating merchandise selection, comprising:
receiving merchandise selection criteria from a purchaser;
receiving merchandise constraints from the purchaser; and
creating a recipient distribution matrix based on the merchandise selection criteria and the merchandise constraints.

27. The method of claim 26 wherein the recipient distribution matrix is used for selecting merchandise for shipment.

28. The method of selecting merchandises comprising generating a merchandise list based on a merchandise selection criteria and a merchandise constraints received from a purchaser.

29. The method of claim 26 further comprising providing the purchaser with choices of merchandise type.

30. The method of claim 26 further comprising receiving a merchandise type from the purchaser.

31. The method of claim 26 further comprising providing the purchaser with merchandise type recipient distribution matrix prompts.

32. The method of claim 26 further comprising receiving recipient group distribution matrix limits from the purchaser.

33. The method of claim 26 further comprising receiving shipment destination information from the purchaser.

34. The method of claim 26 further comprising receiving specific inventory item selections specified by the purchaser.

35. The method of claim 26 wherein the merchandise constraints comprise a maximum monetary amount that the purchaser is willing to pay.

36. The method of claim 26 wherein the merchandise constraints comprise a maximum number of items to be purchased.

37. The method of claim 26 wherein the merchandise constraints comprise a list of merchandise attributes used to filter available inventory, and wherein the merchandise attributes may include required inventory selection and rejection attributes.

38. The method of claim 26 wherein the merchandise constraints comprise a duplicate inventory item limit to set a maximum number of a single inventory item to be purchased.

39. The method of claim 26 further comprising receiving group population distribution information used for determining a group inventory item limit comprising a maximum number of items to be purchased for the group.

40. The method of claim 28 further comprising selecting inventory items for each selection group of a plurality of selection groups based upon a recipient distribution matrix created by a second control system based on the merchandise selection criteria and the merchandise constraints, wherein the second control system further uses filtering constraints of recipient group distribution matrix limits and a list of merchandise attributes used to filter available inventory items, and wherein a subset of the available inventory items is selected as inventory item candidates for the selection group.

41. The method of claim 40 further comprising using a group inventory item limit and a duplicate inventory item limit to scan a group of inventory item candidates, selecting individual inventory items and quantities of the individual inventory items to be included in the merchandise list, wherein first items in the merchandise list comprise specific inventory items from the purchaser.

42. The method of claim 40 further comprising returning to the purchaser a merchandise list of all inventory items selected.

43. The method of claim 40 further comprising processing for approval of the purchaser, wherein the processing comprises receiving from the purchaser either approving or changing the merchandise list and releasing approved merchandise lists to a distribution system, wherein changing the merchandise list may include removing items, changing item quantities, and/or adding new items from an available inventory.

44. The method of claim 42 wherein changing the merchandise list includes removing items, changing item quantities, and/or adding new items from an available inventory.

45. The method of claim 42 further comprising creating separate merchandise lists for each selection group of a plurality of selection groups.

46. The method of claim 41 further comprising aging inventory usage comprising recording a last time an inventory item was selected; setting an order of item selection by oldest use; and assuring that all inventory items are used in a selection process.

47. The method of claim 46 further comprising bypassing aging inventory usage through an inventory sales incentive configured to give specified inventory items precedence over aged items.

48. The method of claim 40 further comprising constraining the inventory candidates to a distribution center logistically closest to a shipment destination.

49. The method of claim 41 further comprising balancing the selection of inventory item candidates based upon each group's distribution ratio of inventory items.

50. The method of claim 40 further comprising selecting a subset of inventory items based upon a Product Value Proposition scale.
